(19) United States
(12) Patent Application Publication
(10) Pub. No.: US 2022/0200798 A1
(43) Pub. Date: Jun. 23, 2022

(54) KEY CODE DATA BURNING METHOD, DEVICE, TERMINAL EQUIPMENT AND READABLE STORAGE MEDIUM

(71) Applicant: SHENZHEN CHUANGWEI-RGB ELECTRONICS CO., LTD., SHENZHEN (CN)

(72) Inventor: Yuming DAI, SHENZHEN (CN)

(73) Assignee: SHENZHEN CHUANGWEI-RGB ELECTRONICS CO., LTD., SHENZHEN (CN)

(21) Appl. No.: 17/254,015

(22) PCT Filed: Oct. 30, 2020
(86) PCT No.: PCT/CN2020/125552

§ 371 Date: May 10, 2021

(30) Foreign Application Priority Data
Jun. 11, 2020 (CN) 202010528447.1

(51) Int. Cl. H04L 9/08

(52) U.S. Cl. CPC H04L 9/0861

(57) ABSTRACT

Provided are a key code data burning method, a key code data burning apparatus, a terminal device and a readable storage medium. In the present disclosure, the name of each folder in the external storage device is identified when the access of the external storage device is detected; the burning function of the device to be burned is waked up when the target folder matched with the feature identifier of the device to be burned is identified; the burning file is determined according to the burning profile in the target folder; the key code burning is performed according to key code data pre-stored in the burning file; and the burning profile is updated when the burning is successful, so as to realize full-automatic burning by the external storage device without using other burning tools, and unified burning still may be realized even in different production technologies.

### CROSS-REFERENCE TO RELATED APPLICATION

The present disclosure claims the priority to the Chinese patent application with the filing No. 2020105284471 filed on Jun. 11, 2020 with the Chinese Patent Office, and entitled “Key Code Data Burning Method, Device, Terminal Equipment and Readable Storage Medium”, the contents of which are incorporated herein by reference in entirety.

### TECHNICAL FIELD

The present disclosure relates to the field of intelligent devices, in particular, to a key code data burning method, a key code data burning apparatus (or device), a terminal device (or terminal equipment) and a readable storage medium.

### BACKGROUND ART

At the present day of rapid development of technologies, smart televisions have already been hot spots nowadays, and when television manufacturers manufacture televisions, specific data information needs to be burned for each television on production line, for example, an HDCP KEY (High-bandwidth Digital Content Protection KEY) code, an MAC (Media Access Control) code of smart television, a bar code of smart television and other data information.

Currently, when the data information is burned on the television in a factory, it is generally a specialized burning device or a dedicated server that transmits the data information to be burned to the television end for burning, and the television end burns the data information into an EEPROM (Electrically Erasable Programmable Read-Only Memory).

However, in the foregoing burning mode, the data information can be burned into an EEPROM chip only through a dedicated server or a specialized burning device, but the resources of the television itself are not fully utilized, which leads to a low utilization ratio of system resources of the smart televisions.

### SUMMARY

In view of the above problems, one of the objectives of the present disclosure is to provide a key code data burning method, a key code data burning apparatus, a terminal device and a readable storage medium, so as to realize full-automatic burning by an external storage device, and ensure a simpler and more convenient burning process.

In order to realize the above objective, a technical solution adopted in an embodiment of the present disclosure is as follows.

In a first aspect, an embodiment of the present disclosure provides a key code data burning method, wherein this method includes:

identifying, when an access of an external storage device is detected, a name of each folder in the external storage device;

waking up, when a target folder matched with a feature identifier of a device to be burned is identified, a burning function of the device to be burned;

determining a burning file according to a burning profile in the target folder;

performing key code burning according to key code data pre-stored in the burning file; and

updating, when the burning is successful, the burning profile.

In a possible implementation, the identifying a name of each folder in the external storage device comprises:

traversing the folders under a root directory of the external storage device; and

identifying, when a folder with a predetermined name is identified, a target folder matched with the feature identifier of the device to be burned in the folder with the predetermined name.

In a possible implementation, the parsing information further includes: at least one of a key code data type, a burning file type, a start address of the key code data, length of the key code data, a check bit of the key code data and a forced burning identifier.

In a possible implementation, the determining a burning file according to a burning profile in the target folder comprises:

parsing the burning profile so as to acquire parsing information, wherein the parsing information comprises a position where the burning file is stored, a front segment identifier of the burning file and an index bit of the burning file; and

determining the burning file according to the position where the burning file is stored, the front segment identifier of the burning file and the index bit of the burning file.

In a possible implementation, the updating the burning profile comprises: updating the index bit the burning file.

In a possible implementation, the method further comprises:

recording, when the burning has an error, burning error data into an error log in the target folder.

In a possible implementation, the type of the key code data comprises at least one of an MAC address, HDCP 1.4 Key, HDCP 2.2 Key and DRM key.

In a second aspect, an embodiment of the present disclosure provides a key code data burning apparatus, wherein the apparatus comprises:

a file name identifying module, configured to identify, when an access of an external storage device is detected, a name of each folder in the external storage device;

a burning function waking-up module, configured to wake up, when a target folder matched with a feature identifier of a device to be burned is identified, a burning function of the device to be burned;

a burning file determining module, configured to determine a burning file according to a burning profile in the target folder;

a key code data burning module, configured perform key code burning according to key code data pre-stored in the burning file; and

a profile updating module, configured to update, when the burning is successful, the burning profile.

In a possible implementation, a manner for the file name identifying module identifying the name of each folder in the external storage device comprises:

traversing folders under a root directory of the external storage device; and

identifying, when a folder with a predetermined name is identified, a target folder matched with the feature identifier of the device to be burned in the folder with the predetermined name.

In a possible implementation, a manner for the burning file determining module determining a burning file according to a burning profile in the target folder comprises:

parsing the burning profile so as to acquire the parsing information, wherein the parsing information comprises a position where the burning file is stored, a front segment identifier of the burning file and an index bit of the burning file; and

determining the burning file according to the position where the burning file is stored, the front segment identifier of the burning file and the index bit of the burning file.

In a possible implementation, the parsing information further comprises at least one of a key code data type, a burning file type, a start address of the key code data, length of the key code data, a check bit of the key code data and a forced burning identifier.

In a possible implementation, a manner for the profile updating module updating the burning profile comprises: updating the index bit of the burning file.

In a possible implementation, the apparatus further comprises:

a burning error recording module, configured to record, when the burning has an error, burning error data into an error log in the target folder.

In a possible implementation, the type of the key code data comprises at least one of an MAC address, HDCP 1.4 Key, HDCP 2.2 Key and DRM key.

In a third aspect, an embodiment of the present disclosure provides a terminal device, comprising a memory and a processor, wherein the memory is configured to store a computer program, and the processor runs the computer program so as to enable the terminal device to execute the above key code data burning method.

In a fourth aspect, an embodiment of the present disclosure provides a readable storage medium, storing a computer program, wherein the computer program, when running on a processor, executes the above key code data burning method.

One the beneficial effects of the embodiment of the present disclosure includes: in the present disclosure, the name of each folder in the external storage device is identified when the access of the external storage device is detected; the burning function of the device to be burned is waked up when the target folder matched with the feature identifier of the device to be burned is identified; the burning profile of the target folder is parsed; the burning file is determined according to the parsing information; the key code burning is performed according to key code data pre-stored in the burning file; and the burning profile is updated when the burning is successful. The technical solutions of the present disclosure realize full-automatic burning by the external storage device without using other burning tools, and also may realize unified burning even in different production technologies. The burning process is simpler and more convenient. Besides, the Key code data burning can be completed only through a simple burning profile, which not only realizes unification of the process, but also saves the preparation time of the Key code data burning and reduces the risk of errors; moreover, the profile may be flexibly modified so as to be adapted to the production requirements of the flow production line.

### BRIEF DESCRIPTION OF DRAWINGS

In order to illustrate the technical solutions of the embodiments of the present disclosure more clearly, the accompanying drawings that need to be used in the embodiments will be briefly introduced below, it should be understood that the following accompanying drawings only show certain embodiments of the present disclosure, thus it should not be seen as a limitation to the scope of protection of the present disclosure. In respective accompanying drawings, similar constitute parts adopt like serial numbers.

FIG. 1 is a schematic flow chart of a key code data burning method provided in an embodiment of the present disclosure;

FIG. 2 is a schematic view of names of various folders in an external storage device provided in an embodiment of the present disclosure;

FIG. 3 is a schematic view of contents of a burning profile provided in an embodiment of the present disclosure; and

FIG. 4 is a structural schematic view of a key code data burning apparatus provided in an embodiment of the present disclosure.

Illustration of Reference Signs of Main Elements:

1—key code data burning apparatus; 100—file name identifying module; 200—burning function waking-up module; 300—burning file determining module; 400—key code data burning module; 500—profile updating module.

### DETAILED DESCRIPTION OF EMBODIMENTS

The technical solutions provided in the embodiments of the present disclosure will be described clearly and completely below in conjunction with the accompanying drawings in the embodiments of the present disclosure, and apparently, the implementations described in the present embodiment are only some of the possible implementations of the present application, but not all implementations.

Generally, components in the embodiments of the present disclosure described and shown in the accompanying drawings herein may be arranged and designed in various different configurations. Therefore, the detailed description below of the embodiments of the present disclosure provided in the accompanying drawings is not intended to limit the scope of the present disclosure claimed, but merely illustrates chosen implementations of the embodiments of the present disclosure. All of other possible implementations obtained by those ordinarily skilled in the art based on the implementations in the embodiments of the present disclosure without using creative efforts shall belong to the scope of protection of the present disclosure.

Hereinafter, terms such as “include”, “have” and cognates thereof that may be used in various implementations of the present disclosure are merely intended to indicate specific features, numbers, steps, operations, elements, components or combinations of the foregoing, and should not be construed as initially excluding the possibility of the presence of one or more other features, numbers, steps, operations, elements, components or combinations of the foregoing or the possibility of the addition of one or more other features, steps, operations, elements, components or combinations of the foregoing.

Besides, terms such as “first”, “second”, and “third” are merely used for distinctive description, but should not be construed as indicating or implying importance in the relativity.

Unless otherwise defined, all terms (including technical terms and scientific terms) used herein have the same meaning as that in various implementations of the present disclosure generally understood by a person ordinarily skilled in the art. The terms (such as terms defined in commonly used dictionaries) shall be construed as having the same meaning as that in the context of relevant technical field and shall not be construed as having an ideal meaning or overformal meaning, unless clearly defined in various embodiments of the present disclosure.

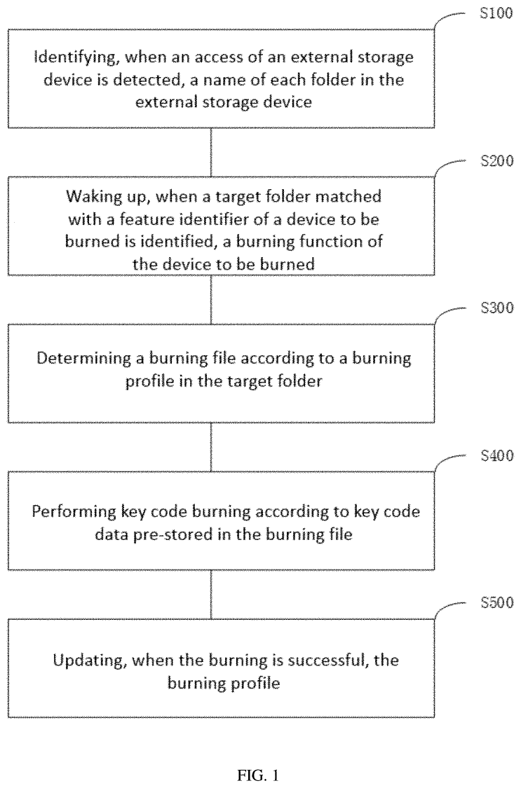

Referring to FIG. 1, an embodiment of the present disclosure provides a key code data burning method, wherein the key code data burning method may include the following steps:

step S100: identifying, when an access of an external storage device is detected, a name of each folder in the external storage device.

In the present embodiment, the external storage device storing key code data may be connected to a device to be burned, and a corresponding connection manner may include directly inserting the external storage device into the device to be burned, and may further include non-contact communication connection between the external storage device and the device to be burned, for example, communication connection such as Bluetooth and WIFI. The external storage device may include a hardware device having a storage function, such as a USB disk and an SD card. In the above, the type of the key code data includes at least one of an MAC address, HDCP 1.4 Key, HDCP 2.2 Key and DRM key.

After the external storage device establishes the connection relationship with the device to be burned, the device to be burned will further identify the name of each folder in the external storage device so as to acquire a target folder.

In a possible implementation of the present embodiment, the step that the device to be burned identifies the name of each folder in the external storage device may include: traversing the folders under a root directory of the external storage device; and identifying, when a folder with a predetermined name is identified, a target folder matched with a feature identifier of the device to be burned in the folder with the predetermined name.

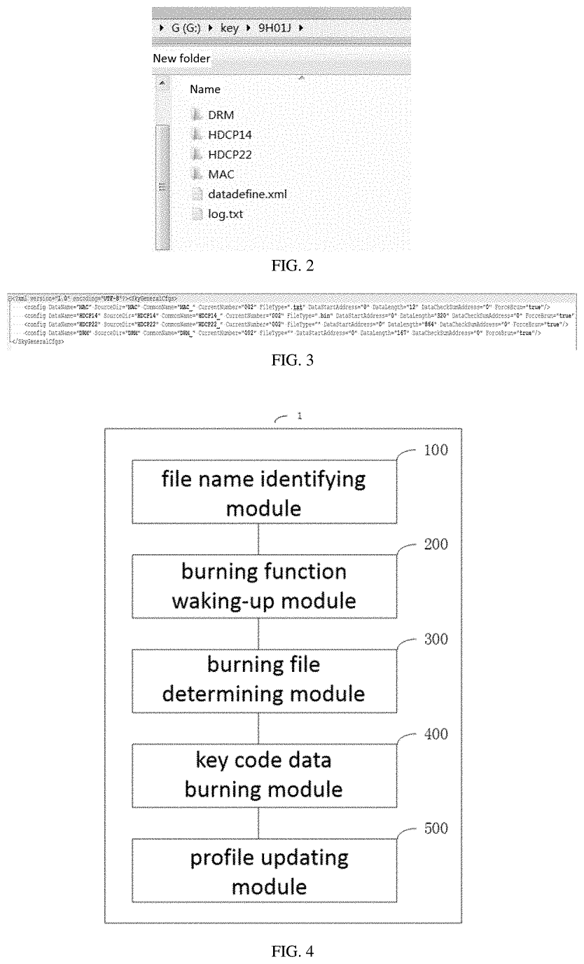

Taking the contents shown in FIG. 2 as an example for illustration, the device to be burned traverses the folders under the root directory of the external storage device, and if a folder with a predetermined name of key is identified, a target folder, folder 9H01J, matched with a feature identifier 9H01J of the device to be burned is identified in the key folder. It may be understood that the predetermined name of the folder with the predetermined name under the root directory may be flexibly modified, and the target folder is also flexibly set according to the feature identifier of the device to be burned.

Step S200: waking up, when the target folder matched with the feature identifier of the device to be burned is identified, a burning function of the device to be burned.

In the present embodiment, if the target folder matched with the feature identifier of the device to be burned is identified under the folder with the predetermined name in the external storage device, the burning function of the device to be burned is waked up, and thus the burning function of the device to be burned is started.

Step S300: determining a burning file according to a burning profile in the target folder.

In the present embodiment, the burning profile is stored under the target folder of the external storage device, and the device to be burned needs to parse the burning profile so as to acquire parsing information, and determine the burning file according to the parsing information. In the above, the parsing information of the burning profile may include a position where the burning file is stored, a burning file front segment identifier and a burning file index bit.

In a possible implementation of the present embodiment, the parsing information of the burning profile may further include at least one of a key code data type, a burning file type, a start address of the key code data, length of the key code data, a check bit of the key code data and a forced burning identifier.

Taking the contents shown in FIG. 2 as an example for illustration, the burning profile under the target folder is a datadefine.xml file. In the above, it may be understood that the burning profile may be any one of an xml type, a txt type, an ini type and other types.

Taking the contents shown in FIG. 3 as an example for illustration, the parsing information of the burning profile includes: a key code data type DataName, a position SourceDir where the burning file is stored, a burning file front segment identifier CommonName, a burning file index bit CurrentNumber, a burning file type FileType, a start address DataStartAddress of the key code data, length DataLength of the key code data, a check bit DataCheckSumAddress of the key code data, and a forced burning identifier forceBrun. The key code data type DataName in FIG. 3 includes an MAC address, HDCP 1.4 Key, HDCP 2.2 Key and DRM key.

At this time, the burning file may be determined according to the position SourceDir where the burning file is stored, the burning file front segment identifier CommonName and the burning file index bit CurrentNumber. For example, according to FIG. 3, the burning file of the MAC address is stored in an MAC folder under the target folder, and name of the burning file of the MAC address includes: MAC_002.

Therefore, in a possible implementation of the present embodiment, the step of determining a burning file according to a burning profile in the target folder may include:

parsing the burning profile so as to acquire the parsing information, wherein the parsing information includes a position where the burning file is stored, a burning file front segment identifier and a burning file index bit; and

determining the burning file according to the position where the burning file is stored, the burning file front segment identifier and the burning file index bit.

Step S400: performing key code burning according to key code data pre-stored in the burning file.

Taking the contents shown in FIG. 3 as an example for illustration, the key code data pre-stored in the burning file whose name includes MAC_002 is burned into the device to be burned.

Step S500: updating, when the burning is successful, the burning profile.

In the present embodiment, when the burning is successful, the burning profile is updated. Then, a next burning file may be acquired according to the updated burning profile.

In a possible implementation of the present embodiment, the step of updating the burning file may include: updating the burning file index bit in the burning profile. Taking the contents shown in FIG. 3 as an example, when the burning is performed according to the burning profile in FIG. 3, and after the current device to be burned succeeds in burning, 002 of the burning file index bit CurrentNumber in FIG. 3 will be automatically updated to 003. Then, after the external storage device is connected to another device to be burned, the another device to be burned will acquire, according to the updated burning profile, the burning file of the burning file index bit CurrentNumber=003, and burn the key code data pre-stored in the burning file of the burning file index bit CurrentNumber=003 into the device to be burned.

Optionally, for a plurality of flow production lines, the burning file index bit may be flexibly modified so as to be adapted to different production requirements.

Taking one example for illustration: for two flow production lines, each production line is planned to perform the key code data burning for 100 devices to be burned, then two external storage devices may be prepared, wherein the burning file index bit of one external storage device may be set to be 000, and after the burning file index bit of the external storage device is updated from 000 to 099, the key code data burning for 100 devices to be burned is completed. The burning file index bit of the other external storage device may be set to be 100, and after the burning file index bit of the external storage device is updated from 100 to 199, the key code data burning for the 100 devices to be burned is completed.

Optionally, in an embodiment of the present disclosure, the above key code data burning method further includes a following step: recording, when the burning has an error, burning error data into an error log in the target folder.

Taking the contents shown in FIG. 2 for illustration, a log.txt file stored under the target folder of the external storage device may store the burning error data. The burning error data may include information such as time when the burning error data is generated, a model of a device to be burned corresponding to the burning error, a detailed burning error cause and a corresponding error sequence number. The above burning error data not only contributes to tracking the burning situation later, but also contributes to exception repair and upgrade of a burning system later. It should be understood that the burning profile is not updated when the burning has an error.

In a possible implementation of the present embodiment, the burning log and the burning result of the above burning may be displayed on a corresponding display screen in real time, which is helpful for a user to acquire the burning situation in time.

Thus, in an embodiment of the present disclosure, names of various folders in the external storage device may be identified in the case that the access of the external storage device is detected; when the target folder matched with the feature identifier of the device to be burned is identified, the burning function of the device to be burned is waked up; the burning profile of the target folder is parsed; the burning file is determined according to the parsing information; and the key code burning is performed on the key code data pre-stored in the burning file; and the burning profile is updated after the burning is successful. The technical solutions of the embodiments of the present disclosure realize full-automatic burning by the external storage device without using other burning tools, and still may realize unified burning even in different production technologies, then the burning process is simpler and more convenient.

Besides, the Key code data burning can be completed only through a simple burning profile, which not only realizes unification of the process, but also saves the preparation time of the Key code data burning and reduces the risk of errors; moreover, the profile may be flexibly modified so as to be adapted to the production requirements of the flow production line.

Referring to FIG. 4, an embodiment of the present disclosure may provide a key code data burning apparatus 1 for executing the above key code data burning method by various software functional modules included in the key code data burning apparatus 1. In the above, the key code data burning apparatus 1 may include a file name identifying module 100, a burning function waking-up module 200, a burning file determining module 300, a key code data burning module 400 and a profile updating module 500.

The file name identifying module 100 is configured to identify, when an access of an external storage device is detected, a name of each folder in the external storage device.

The burning function waking-up module 200 is configured to wake up, when the target folder matched with the feature identifier of the device to be burned is identified, a burning function of the device to be burned.

The burning file determining module 300 is configured to determine a burning file according to a burning profile in the target folder.

The key code data burning module 400 is configured perform key code burning according to key code data pre-stored in the burning file.

The profile updating module 500 is configured to update, when the burning is successful, the burning profile.

In a possible implementation of the present embodiment, a manner for the file name identifying module 110 identifying the name of each folder in the external storage device includes:

traversing folders under a root directory of the external storage device; and

identifying, when a folder with a predetermined name is identified, a target folder matched with a feature identifier of the device to be burned in the folder with the predetermined name.

In a possible implementation of the present embodiment, a manner for the burning file determining module 300 determining a burning file according to a burning profile in the target folder includes:

parsing the burning profile so as to acquire the parsing information, wherein the parsing information includes a position where the burning file is stored, a burning file front segment identifier and a burning file index bit; and

determining the burning file according to the position where the burning file is stored, the burning file front segment identifier and the burning file index bit.

In the above, the parsing information further may include at least one of a key code data type, a burning file type, a start address of the key code data, length of the key code data, a check bit of the key code data and a forced burning identifier.

In a possible implementation of the present embodiment, a manner for the profile updating module 500 updating the burning profile includes: updating the burning file index bit.

In the above, the type of the key code data includes at least one of an MAC address, HDCP 1.4 Key, HDCP 2.2 Key and DRM key.

In a possible implementation of the present embodiment, the key code data burning apparatus 1 further may include a burning error recording module. The burning error recording module is configured to record, when the burning has an error, burning error data into an error log in the target folder.

It should be noted that, the key code data burning apparatus 1 provided in the embodiment of the present disclosure can execute the above key code data burning method at least through the cooperation between the file name identifying module 100, the burning function waking-up module 200, the burning file determining module 300, the key code data burning module 400 and the profile updating module 500. The basic principle of the key code data burning apparatus 1 and the technical effects produced are the same as the aforementioned key code data burning method, and for the sake of concise description, reference may be made to the above descriptive contents of the key code data burning method for contents which are not mentioned in the part of the embodiments of the present disclosure, which is not repeated herein.

Besides, an embodiment of the present disclosure further provides a terminal device, including a memory and a processor. The memory is configured to store a computer program, and the processor runs the computer program so as to enable the terminal device to execute the above key code data burning method.

In the above, the above terminal device may include a smart television and other smart devices that need to perform data burning. The memory may include one or more computer program products, and the computer program products may include various forms of readable storage media, such as volatile memory and/or non-volatile memory. The volatile memory may include, for example, random access memory and/or cache memory, etc. The non-volatile memory may include, for example, read-only memory, hard disk, flash memory, etc. One or more computer programs may be stored on the readable storage medium, and the processor may run the computer programs so as to implement functions represented by the key code data burning method and/or other desired functions. Various application programs and various data may be stored in the readable storage medium, for example, various data used and/or generated by the application programs.

The processor may be implemented in at least one hardware form of a digital signal processor, a field programmable gate array, and a programmable logic array, the processor may be a central processing unit or one or a combination of more of other forms of processing units having data processing capability and/or instruction execution capability, and other components in the control device may be controlled to perform a desired function. The processor may accordingly execute the computer program stored in the memory so as to implement the functions represented by the computer program.

In a possible implementation of the present embodiment, the above key code data burning apparatus 1 may be stored in a memory of the terminal device in the form of software or firmware, and a processor of the terminal device executes a software function module and a computer program included in the key code data burning apparatus 1 in the memory, so as to implement functions corresponding to the above key code data burning method.

It should be understood that an embodiment of the present disclosure further may provide a readable storage medium, which stores a computer program, and when running on a processor of a corresponding electronic device, the computer program executes the key code data burning method described in the above embodiments.

In the several embodiments provided in the present disclosure, it should be understood that the apparatus and the method disclosed also may be implemented in other manners. The apparatus embodiments described above are merely illustrative, for example, the flow chart and the structural views in the accompanying drawings show possible system structures, functions and operations of the apparatus, method, and computer program products according to multiple embodiments of the present disclosure. In this regard, each block in the flow chart or the block may represent a part of one module, program segment or code, and the part of the module, program segment or code contains one or more executable instructions configured to achieve a specified logical function. It also should be noted that in implementations as substitutions, the functions marked in the blocks also may proceed in an order different from that marked in the accompanying drawings. For example, two consecutive blocks practically may be executed substantially in parallel, and they sometimes also may be executed in a reverse order, which depends upon the function involved. It also should be noted that each block in the structural view and/or flow chart, and combinations of the blocks in the structural view and/or the flow chart may be realized by a dedicated hardware-based system configured to execute a specified function or action, or may be realized by a combination of dedicated hardware and computer instructions.

Besides, various functional modules in various embodiments of the present disclosure may be integrated together to form one independent part, and it is also possible that various modules exist independently, or that two or more modules are integrated to form one independent part.

If the function is realized in a form of software functional module and is sold or used as an individual product, it may be stored in one computer readable storage medium. Based on such understanding, the technical solutions in essence or parts making contribution to the prior art or parts of the technical solutions of the present disclosure may be embodied in form of a software product, and this computer software product is stored in a storage medium, including several instructions for making one computer device (which may be a smart cellphone, a personal computer, a server or a network device etc.) execute all or part of the steps of the methods of various examples of the present disclosure. The aforementioned storage medium includes various media in which program codes can be stored, such as U disk, mobile hard disk, Read-Only Memory (ROM), Random Access Memory (RAM), diskette and compact disk.

The above-mentioned are merely possible implementations of the embodiments of the present disclosure, but the scope of protection of the present disclosure is not limited thereto, and any modification or substitution that may be easily envisaged by those skilled in the present art within the technical scope disclosed in the present disclosure should be covered within the scope of protection of the present disclosure.

### INDUSTRIAL APPLICABILITY

The embodiments of the present disclosure provide a key code data burning method, a key code data burning apparatus, a terminal device and a readable storage medium. The name of each folder in the external storage device is identified when the access of the external storage device is detected; the burning function of the device to be burned is waked up when the target folder matched with the feature identifier of the device to be burned is identified; the burning profile of the target folder is parsed; the burning file is determined according to the parsing information; the key code burning is performed according to key code data pre-stored in the burning file; and the burning profile is updated when the burning is successful, so as to realize full-automatic burning by the external storage device without using other burning tools, moreover, unified burning still may be realized even in different production technologies. The burning process is simpler and more convenient. Besides, the Key code data burning can be completed only through a simple burning profile, which not only realizes unification of the process, but also saves the preparation time of the Key code data burning and reduces the risk of errors; moreover, the profile may be flexibly modified so as to be adapted to the production requirements of the flow production line.

1. A key code data burning method, wherein the method comprises:
identifying, when an access of an external storage device is detected, a name of each folder in the external storage device;
waking up, when a target folder matched with a feature identifier of a device to be burned is identified, a burning function of the device to be burned;
determining a burning file according to a burning profile in the target folder;
performing key code burning according to key code data pre-stored in the burning file; and
updating, when the burning is successful, the burning profile.

2. The key code data burning method according to claim 1, wherein the identifying a name of each folder in the external storage device comprises:
traversing folders under a root directory of the external storage device; and
identifying, when a folder with a predetermined name is identified, the target folder matched with the feature identifier of the device to be burned in the folder with the predetermined name.

3. The key code data burning method according to claim 1, wherein the determining a burning file according to a burning profile in the target folder comprises:
parsing the burning profile so as to acquire parsing information, wherein the parsing information comprises a position where the burning file is stored, a front segment identifier of the burning file and an index bit of the burning file; and
determining the burning file according to the position where the burning file is stored, the front segment identifier of the burning file and the index bit of the burning file.

4. The key code data burning method according to claim 3, wherein the parsing information further comprises at least one of a type of the key code data, a type of the burning file, a start address of the key code data, a length of the key code data, a check bit of the key code data and a forced burning identifier.

5. The key code data burning method according to claim 3, wherein the updating the burning profile comprises: updating the index bit of the burning file.

6. The key code data burning method according to claim 1, wherein the method further comprises:
recording, when the burning has an error, burning error data into an error log in the target folder.

7. The key code data burning method according to claim 1, wherein a type of the key code data comprises at least one of an MAC address, HDCP 1.4 Key, HDCP 2.2 Key and DRM key.

8. A key code data burning apparatus, wherein the apparatus comprises:
a file name identifying module, configured to identify, when an access of an external storage device is detected, a name of each folder in the external storage device;
a burning function waking-up module, configured to wake up, when a target folder matched with a feature identifier of a device to be burned is identified, a burning function of the device to be burned;
a burning file determining module, configured to determine a burning file according to a burning profile in the target folder;
a key code data burning module, configured perform key code burning according to key code data pre-stored in the burning file; and
a profile updating module, configured to update, when the burning is successful, the burning profile.

9. The key code data burning apparatus according to claim 8, wherein the file name identifying module identifies the name of each folder in the external storage device in a manner comprising:
traversing folders under a root directory of the external storage device; and
identifying, when a folder with a predetermined name is identified, the target folder matched with the feature identifier of the device to be burned in the folder with the predetermined name.

10. The key code data burning apparatus according to claim 8, wherein the burning file determining module determines the burning file according to the burning profile in the target folder in a manner comprising:
parsing the burning profile so as to acquire parsing information, wherein the parsing information comprises a position where the burning file is stored, a front segment identifier of the burning file and an index bit of the burning file; and
determining the burning file according to the position where the burning file is stored, the front segment identifier of the burning file and the index bit of the burning file.

11. The key code data burning apparatus according to claim 10, wherein the parsing information further comprises at least one of a type of the key code data, a type of the burning file, a start address of the key code data, a length of the key code data, a check bit of the key code data and a forced burning identifier.

12. The key code data burning apparatus according to claim 10, wherein the profile updating module updates the burning profile in a manner comprising: updating the index bit of the burning file.

13. The key code data burning apparatus according to claim 8, wherein the apparatus further comprises:
a burning error recording module, configured to record, when the burning has an error, burning error data into an error log in the target folder.

14. The key code data burning apparatus according to claim 8 any one of claims 8-13, wherein a type of the key code data comprises at least one of an MAC address, HDCP 1.4 Key, HDCP 2.2 Key and DRM key.

15. A terminal device, comprising a memory and a processor, wherein the memory is configured to store a computer program, and the processor runs the computer program, so as to enable the terminal device to execute the key code data burning method according to claim 1.

16. (canceled)

17. The key code data burning method according to claim 2, wherein the determining a burning file according to a burning profile in the target folder comprises:
parsing the burning profile so as to acquire parsing information, wherein the parsing information comprises a position where the burning file is stored, a front segment identifier of the burning file and an index bit of the burning file; and
determining the burning file according to the position where the burning file is stored, the front segment identifier of the burning file and the index bit of the burning file.

18. The key code data burning method according to claim 4, wherein the updating the burning profile comprises: updating the index bit of the burning file.

19. The key code data burning method according to claim 2, wherein the method further comprises:
recording, when the burning has an error, burning error data into an error log in the target folder.

20. The key code data burning method according to claim 2, wherein a type of the key code data comprises at least one of an MAC address, HDCP 1.4 Key, HDCP 2.2 Key and DRM key.

21. The key code data burning apparatus according to claim 9, wherein the burning file determining module determines the burning file according to the burning profile in the target folder in a manner comprising:
parsing the burning profile so as to acquire parsing information, wherein the parsing information comprises a position where the burning file is stored, a front segment identifier of the burning file and an index bit of the burning file; and
determining the burning file according to the position where the burning file is stored, the front segment identifier of the burning file and the index bit of the burning file.
